(19) United States
(12) Patent Application Publication
(10) Pub. No.: US 2010/0127926 A1
(43) Pub. Date: May 27, 2010

(54) ELECTRONIC DEVICE AND POWER CONSERVATION METHOD THEREOF

(75) Inventor: XU-JUAN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/565,884

(22) Filed: Sep. 24, 2009

(30) Foreign Application Priority Data
Nov. 21, 2008 (CN) 200810305697.8

(51) Int. Cl. G01S 1/00

(52) U.S. Cl. 342/357.09

(57) ABSTRACT

An electronic device and method for conserving power of a global position system (GPS) include setting a time interval to acquire movement parameters of the electronic device, and activating the GPS and a three-axis accelerometer to acquire the movement parameters of the electronic device. The electronic device and method further include determining if the electronic device is at rest, maintaining an active state of the GPS if the electronic device is not at rest, or disabling the GPS if the electronic device is at rest.

### BACKGROUND

1. Technical Field

Embodiments of the present disclosure relate to power management, and more particularly to an electronic device and a power conservation method of the electronic device.

2. Description of Related Art

Electronic devices, such as mobile phones, provide increasing number of functions, such as the ability to locate the electronic device, play music, and capture images, for example. However, each function consumes power of the electronic device, making power conservation in the electronic device important.

What is needed, therefore, is an electronic device capable of conserving power and a method for conserving power utilized in the device.

### BRIEF DESCRIPTION OF THE DRAWINGS

FIG. 1 is a block diagram of one embodiment of an electronic device including a power conservation system.

FIG. 2 is a block diagram of one embodiment of the power conservation system.

FIG. 3 is a flowchart of one embodiment of a method for conserving power consumption of a global position system in the electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

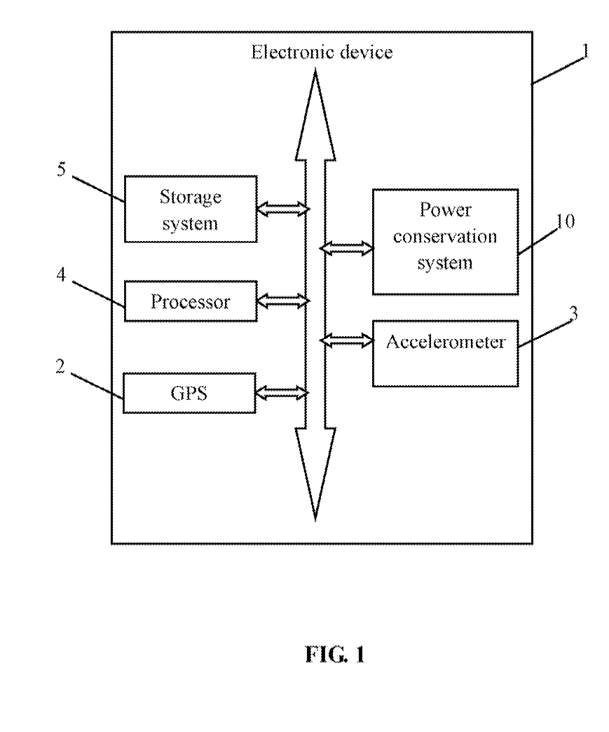

FIG. 1 is a block diagram of one embodiment of an electronic device 1 including a power conservation system conservation system 10. The electronic device 1 also includes a global position system (GPS) 2. The GPS 2 provides a position of the electronic device 1. The power conservation system 10 saves power consumption of the GPS 2. In one embodiment, the GPS 2 does not need to determine the position of the electronic device 1 when the electronic device 1 is at rest. The power conservation system 10 may disable the GPS 2 when the electronic device 1 is at rest, thus conserving power of the GPS 2 and the electronic device 1.

The electronic device 1 may be a mobile phone, a personal digital assistant, a palm, or any other kind of computing device. The electronic device 1 further includes an accelerometer 3, a processor 4, and a storage system 5. The accelerometer 3 may detect an acceleration and a moving direction of the electronic device 1. In one embodiment, the accelerometer 3 may be a three-axis accelerometer, for example.

The processor 4 executes one or more computerized operations of the electronic device 1 and other applications, to provide the functions of the electronic device 1. The storage system 5 stores one or more programs, such as programs of an operating system, other applications of the electronic device 1, and various kinds of data, such as position information of the electronic device 1, messages, E-mails, for example. In one embodiment, the electronic device 1 may be a mobile phone, and the storage system 5 may be a memory of the electronic device 1 or an external storage card, such as a memory stick, a subscriber identification module (SIM) card, a smart media card, a compact flash card, or any other type of memory card.

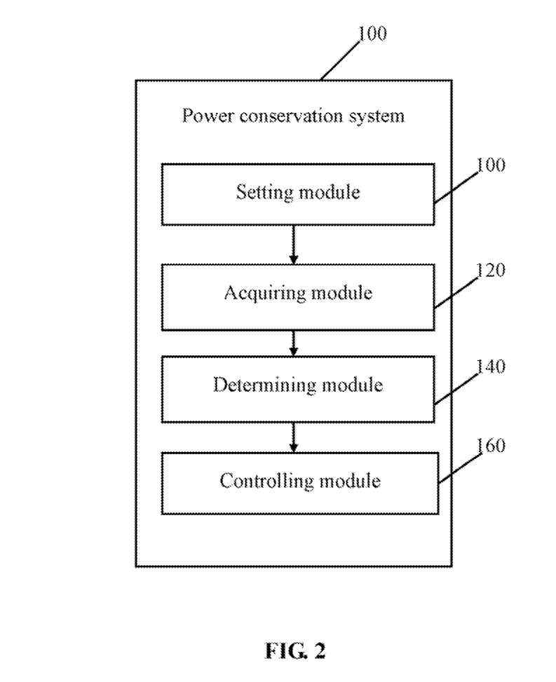

FIG. 2 is a block diagram of one embodiment of the power conservation system 10. In one embodiment, the power conservation system 10 includes a setting module 100, an acquiring module 120, a determining module 140, and a controlling module 160. The modules 100, 120, 140, and 160 may comprise one or more computerized codes to be executed by the processor 4 to perform one or more operations of the electronic device 1. Details of these operations will be provided below.

The setting module 100 may be used to set a time interval to acquire movement parameters of the electronic device 1. In one embodiment, the movement parameters may include, but are not limited to, an acceleration and a moving direction of the electronic device 1. The time interval may be set at 0.01 seconds, for example. The movement parameters and the time interval may be used to determine if the electronic device 1 is moving or at rest.

The setting module 100 may be also used to set a hotkey of the electronic device 1 to enable/disable the GPS 2. In one embodiment, the hotkey may be any key or a key combination on the electronic device 1. In another embodiment, the hotkey may be a character string including alphanumeric characters and/or symbols, such as “#gps#.”

The acquiring module 120 activates the GPS 2 and the accelerometer 3, and acquires the movement parameters of the electronic device 1 using the accelerometer at each time interval. In one embodiment, the GPS 2 may be activated automatically when the electronic device 1 is powered on, or be activated by the hotkey. When the power conservation system 10 is enabled, the accelerometer 3 is activated once the GPS 2 is activated. The accelerometer 3 is activated to acquire the movement parameters of the electronic device 1, thereby determining if the electronic device 1 is at rest. When the GPS 2 is activated, the GPS 2 enters an active state.

The acquiring module 120 further stores the movement parameters into the storage system 5. Depending on the embodiment, the setting module 100 may allocate specified storage space to store the movement parameters of the electronic device 1, and clear the stored movement parameters when the power conservation system 10 is disabled/turned off.

The determining module 140 determines if the electronic device 1 is at rest according to the time interval and the movement parameters.

If the electronic device 1 is not at rest, that is, the electronic device 1 is moving, the controlling module 160 maintains the active state of the GPS 2. If the electronic device 1 is at rest, the controlling module 160 disables the GPS 2.

If the GPS 2 has been disabled and the determining module 140 determines that the electronic device 1 has started moving, the controlling module may reactivate the GPS 2 to locate the position of the electronic device 1.

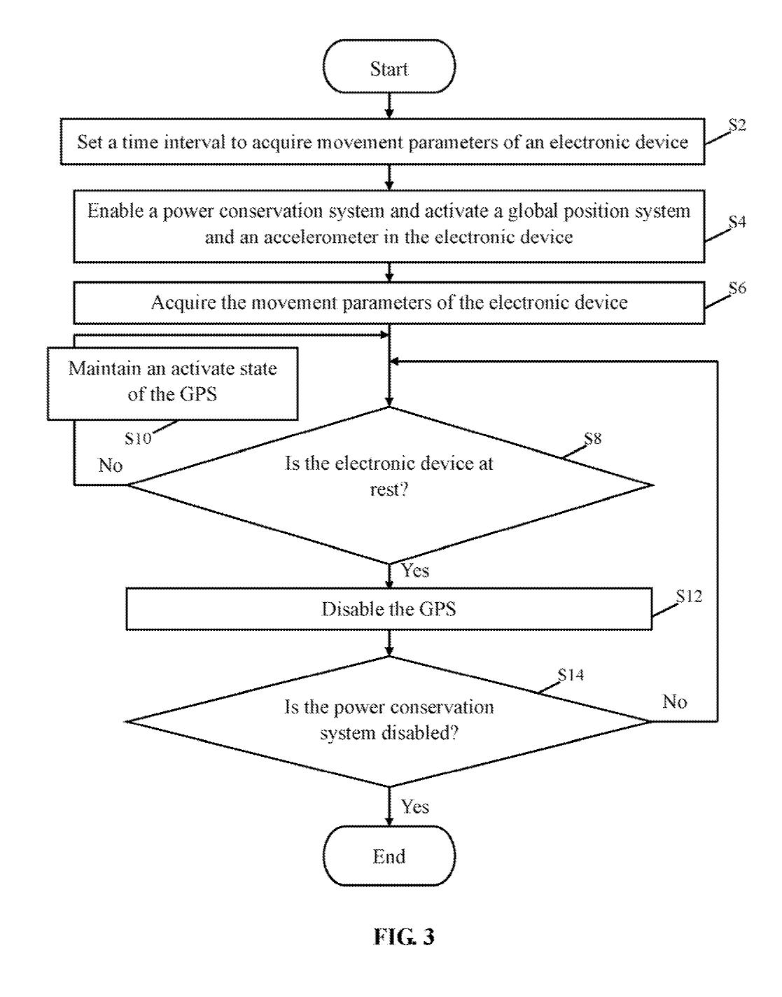

FIG. 3 is a flowchart of one embodiment of a method for conserving power consumption of a global position system in the electronic device of FIG. 1. Depending on the embodiment, additional blocks may be added, others removed, and the ordering of the blocks may be replaced.

In block S2, the setting module 100 sets a time interval to acquire movement parameters of the electronic device 1. As mentioned above, the movement parameters may include, but are not limited to, an acceleration and a moving direction of the electronic device 1. The time interval may be set at 0.01 seconds, for example. The movement parameters and the time interval may be used to determine if the electronic device 1 is moving or at rest.

In block S4, the acquiring module 120 activates the GPS 2 and the accelerometer 3. As mentioned above, if the power conservation system 10 is enabled, the accelerometer 3 is activated once the GPS 2 is activated. The accelerometer 3 is activated to acquire the movement parameters of the electronic device 1 and determine if the electronic device 1 is at rest. When the GPS 2 is activated, the GPS 2 enters an active state.

In block S6, the acquiring module 120 acquires the movement parameters of the electronic device 1 using the accelerometer at each time interval, and stores the movement parameters into the storage system 5.

In block S8, the determining module 140 determines if the electronic device 1 is at rest according to the time interval and the movement parameters. If the electronic device 1 is not at rest, that is, the electronic device 1 is moving, in block S10, the controlling module 160 maintains the active state of the GPS 2. If the electronic device 1 is at rest, in block S12, the controlling module 160 disables the GPS 2.

In block S14, the determining module 140 determines if the power conservation system 10 is disabled. If the power conservation system 10 is still enabled, the procedure returns to block S8. Otherwise, if the power conservation system 10 is disabled, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A power conservation method for a global position system (GPS) in an electronic device, the method comprising:
setting a time interval to acquire movement parameters of the electronic device, the movement parameters comprising an acceleration and a moving direction of the electronic device;
activating the GPS and an accelerometer in the electronic device;
acquiring the movement parameters of the electronic device using the accelerometer at each time interval;
determining if the electronic device is at rest according to the time interval and the movement parameters; and
maintaining an active state of the GPS if the electronic device is not at rest; or
disabling the GPS if the electronic device is at rest.

2. The method according to claim 1, further comprising:
reactivating the GPS in response to determine that the electronic device has started moving after the GPS has been disabled.

3. The method according to claim 1, further comprising:
setting a hotkey of the electronic device to enable or disable the GPS.

4. The method according to claim 1, further comprising:
storing the movement parameters into a storage system of the electronic device.

5. The method according to claim 1, wherein the electronic device is a mobile phone, a personal digital assistant, or a palm.

6. An electronic device capable of conserving power of a global position system (GPS) thereof, the electronic device comprising:
an accelerometer;
a storage system;
at least one processor; and
one or more programs stored in the storage system and being executable by the at least one processor, the one or more programs comprising:
a setting module operable to set a time interval to acquire movement parameters of the electronic device, the movement parameters comprising an acceleration and a moving direction of the electronic device;
an acquiring module operable to activate the GPS and the accelerometer, and acquire the movement parameters of the electronic device using the accelerometer at each time interval;
a determining module operable to determine if the electronic device is at rest according to the time interval and the movement parameters; and
a controlling module operable to maintain an active state of the GPS if the electronic device is not at rest, or disable the GPS if the electronic device is at rest.

7. The electronic device according to claim 6, wherein the controlling module is further operable to reactivate the GPS in response to determine that the electronic device has started moving after the GPS has been disabled.

8. The electronic device according to claim 6, wherein the setting module is further operable to set a hotkey of the electronic device to enable or disable the GPS.

9. The electronic device according to claim 6, wherein the acquiring module is further operable to store the movement parameters into the storage system.

10. The electronic device according to claim 6, wherein the electronic device is a mobile phone, a personal digital assistant, or a palm.

11. A storage medium storing a set of instructions, the set of instructions capable of being executed by a processor to perform a power conservation method for a global position system (GPS) in an electronic device, the method comprising:
setting a time interval to acquire movement parameters of the electronic device, the movement parameters comprising an acceleration and a moving direction of the electronic device;
activating the GPS and an accelerometer in the electronic device;
acquiring the movement parameters of the electronic device using the accelerometer at each time interval;
determining if the electronic device is at rest according to the time interval and the movement parameters; and
maintaining an active state of the GPS if the electronic device is not at rest; or
disabling the GPS if the electronic device is at rest.

12. The storage medium as claimed in claim 11, wherein the method further comprises:
reactivating the GPS in response to determine that the electronic device has started moving after the GPS has been disabled.

13. The storage medium as claimed in claim 11, wherein the method further comprises:
setting a hotkey of the electronic device to enable or disable the GPS.

14. The storage medium as claimed in claim 11, wherein the method further comprises:
storing the movement parameters into a storage system of the electronic device.

15. The storage medium as claimed in claim 11, wherein the electronic device is a mobile phone, a personal digital assistant, or a palm.
